(19) United States
(12) Patent Application Publication
(10) Pub. No.: US 2013/0242161 A1
(43) Pub. Date: Sep. 19, 2013

(54) SOLID-STATE IMAGING DEVICE AND PORTABLE INFORMATION TERMINAL

(71) Applicants: Mitsuyoshi Kobayashi, Yokohama-shi (JP); Risako Ueno, Tokyo (JP); Kazuhiro Suzuki, Tokyo (JP); Hiroto Honda, Yokohama-shi (JP); Hideyuki Funaki, Tokyo (JP)

(72) Inventors: Mitsuyoshi Kobayashi, Yokohama-shi (JP); Risako Ueno, Tokyo (JP); Kazuhiro Suzuki, Tokyo (JP); Hiroto Honda, Yokohama-shi (JP); Hideyuki Funaki, Tokyo (JP)

(21) Appl. No.: 13/714,960

(22) Filed: Dec. 14, 2012

(30) Foreign Application Priority Data
Mar. 15, 2012 (JP) 2012-058831

(51) Int. Cl. H04N 5/225

(52) U.S. Cl. CPC H04N 5/2254
USPC 348/340

(57) ABSTRACT

A solid-state imaging device according to an embodiment includes: an imaging element including a plurality of pixel blocks each containing a plurality of pixels; a first optical system forming an image of an object on an imaging plane; and a second optical system including a microlens array, the microlens array including a light transmissive substrate, a plurality of first microlenses formed on the light transmissive substrate, and a plurality of second microlenses formed around the first microlenses, a focal length of the first microlenses being substantially equal to a focal length of the second microlenses, an area of the first microlenses in contact with the light transmissive substrate being larger than an area of the second microlenses in contact with the light transmissive substrate, the second optical system being configured to reduce and reconstruct the image formed on the imaging plane on the pixel blocks via the microlens array.

### CROSS-REFERENCE TO RELATED APPLICATION

This application is based upon and claims the benefit of priority from prior Japanese Patent Application No. 2012-58831 filed on Mar. 15, 2012 in Japan, the entire contents of which are incorporated herein by reference.

### FIELD

Embodiments described herein relate generally to solid-state imaging devices and portable information terminals.

### BACKGROUND

Various techniques such as a technique using reference light and a stereo ranging technique using two or more cameras have been suggested as imaging techniques for obtaining two-dimensional array information about distances in the depth direction. Particularly, in recent years, there has been an increasing demand for relatively inexpensive products as novel input devices for consumer use.

As one of ranging and imaging techniques that do not involve reference light so as to lower system costs, there is a triangulation technique using parallax. In conjunction with this technique, stereo cameras and compound-eye cameras are known. In such cases, however, more than one camera is used, resulting in problems such as an excessive increase in system size and an increase in failure rate due to a larger number of components.

There is a suggested structure in which the microlens array is placed above pixels, and more than one pixel is placed below each microlens. With this structure, a set of images with parallax can be obtained on the basis of pixel blocks, and refocusing and the like can be performed based on object distance estimates and distance information using the parallax. In a solid-state imaging element using the above-described structure, a calibration image is captured and binarized, and the coordinates are determined by performing contour fitting, to detect the positions in which images of the microlenses are formed. By this method, however, there are times when the center coordinates cannot be accurately determined due to dust or a scratch on the microlenses or the sensor, or variations among the individual microlenses. Also, the calibration image needs to be captured prior to actual image capturing.

### BRIEF DESCRIPTION OF THE DRAWINGS

FIG. 1 is a block diagram of a solid-state imaging device according to a first embodiment;

FIG. 2 is a diagram showing a first example of the optical system of the solid-state imaging device;

FIG. 3 is a diagram showing a second example of the optical system of the solid-state imaging device;

FIG. 4 is a diagram for explaining microlenses;

FIGS. 5(a) and 5(b) are diagrams for explaining the microlens array used in the first embodiment;

FIG. 6 is a cross-sectional view of a first example of the microlens array used in the first embodiment;

FIG. 7 is a cross-sectional view of a second example of the microlens array used in the first embodiment;

FIG. 8 is a diagram for explaining images of an imaging microlens and marker microlenses;

FIG. 9 is a diagram showing a microlens image in a case where there is dust or a scratch on the microlens array;

FIG. 10 is a diagram showing a microlens image in a case where there is dust or a scratch on the microlens array;

FIGS. 11(a) through 11(c) are diagrams for explaining the effects of marker microlenses on image fitting;

FIG. 12 is a flowchart showing the procedures for obtaining a two-dimensional image by using marker microlenses;

FIG. 13 is a flowchart showing the procedures for obtaining a two-dimensional image by using marker microlenses;

FIG. 14 is a diagram for explaining a case where color filters are provided on the microlens array;

FIG. 15 is a diagram for explaining the effects of the use of white pixels provided in the regions where images of the marker microlenses are formed;

FIG. 16 is a diagram showing an optical system in a case where polarizing plates are placed on the plain surface of the microlens array;

FIG. 17 is a diagram showing a situation where several kinds of polarizing plates with different polarizing axes are located around an imaging microlens;

FIG. 18 is a graph showing the polarizing axis angle dependence of the marker microlenses relative to light intensity;

FIG. 19 is a diagram showing a two-dimensional principal polarizing axis distribution obtained by the solid-state imaging device of the first embodiment; and

FIG. 20 is a diagram showing a portable information terminal according to a second embodiment.

### DETAILED DESCRIPTION

A solid-state imaging device according to an embodiment includes: an imaging element including a plurality of pixel blocks each containing a plurality of pixels; a first optical system configured to form an image of an object on an imaging plane; and a second optical system including a microlens array, the microlens array including a light transmissive substrate, a plurality of first microlenses formed on the light transmissive substrate, and a plurality of second microlenses formed around the first microlenses, a focal length of the first microlenses being substantially equal to a focal length of the second microlenses, an area of the first microlenses in contact with the light transmissive substrate being larger than an area of the second microlenses in contact with the light transmissive substrate, the second optical system being located between the imaging element and the first optical system, the second optical system being configured to reduce and reconstruct the image formed on the imaging plane on the pixel blocks via the microlens array.

The following is a description of embodiments, with reference to the accompanying drawings.

### First Embodiment

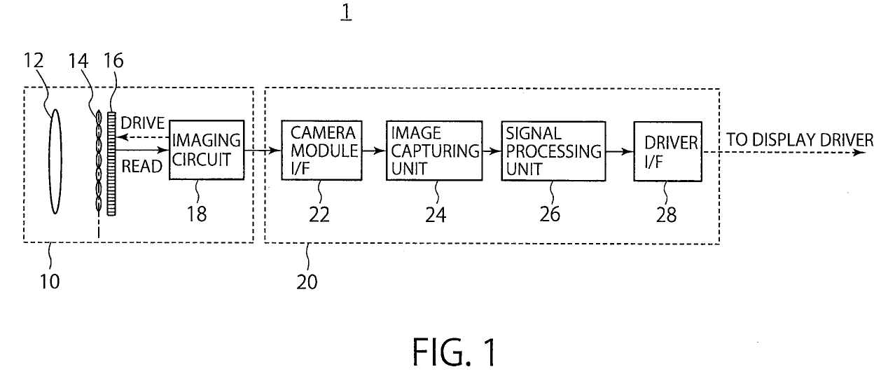

Referring to FIGS. 1 through 11(c), an imaging device according to a first embodiment is described. FIG. 1 shows a solid-state imaging device (also referred to as a camera module) according to the first embodiment. The solid-state imaging device 1 of the first embodiment includes an imaging module unit 10 and an image signal processor (hereinafter also referred to as ISP) 20.

The imaging module unit 10 includes imaging optics 12, a microlens array 14, an imaging element 16, and an imaging circuit 18. The imaging optics 12 includes one or more lenses, and functions as an imaging optical system that captures light from an object into the imaging element 16. The imaging element 16 functions as an element that converts the light captured by the imaging optics 12 to signal charges, and has pixels (such as photodiodes serving as photoelectric conversion elements) arranged in a two-dimensional array. Each of the pixels is an R pixel having a layer with high transmittance in the red wavelength range (a red color filter), or a G pixel having a layer with high transmittance in the green wavelength range (a green color filter), and a B pixel having a layer with high transmittance in the blue wavelength range (a blue color filter).

The microlens array 14 is a microlens array that includes microlenses, or is a micro optical system that includes prisms, for example. The microlens array 14 functions as an optical system that reduces and reconstructs a group of light beams imaged on the imaging plane by the imaging optics 12, into pixel blocks corresponding to the respective microlenses. Each of the pixel blocks includes pixels, and overlaps with one microlens in a direction parallel to the optical axis of the imaging optics 12 (the z-direction). The pixel blocks and the microlenses have one-to-one correspondence. The pixel blocks have the same sizes as the microlenses, or are larger than the microlenses. The imaging circuit 18 includes a drive circuit unit (not shown) that drives the respective pixels of the pixel array of the imaging element 16, and a pixel signal processing circuit unit (not shown) that processes signals output from the pixel region. The drive circuit unit includes a vertical select circuit that sequentially selects pixels to be driven for each line (row) parallel to the vertical direction, a horizontal select circuit that sequentially selects pixels for each column, and a TG (timing generator) circuit that drives those select circuits with various pulses. The pixel signal processing circuit unit includes an A-D converter circuit that converts analog electrical signals supplied from the pixel region into digital signals, a gain adjustment/amplifier circuit that performs gain adjustments and amplifying operations, and a digital signal processing circuit that performs corrections and the like on digital signals.

The ISP 20 includes a camera module interface (I/F) 22, an image capturing unit 24, a signal processing unit 26, and a driver interface 28. A RAW image obtained through an imaging operation performed by the imaging module unit 10 is captured from the camera module interface 22 into the image capturing unit 24. The signal processing unit 26 performs signal processing on the RAW image captured into the image capturing unit 24. The driver interface 28 outputs the image signal subjected to the signal processing performed by the signal processing unit 26, to a display driver (not shown). The display driver displays the image formed by the solid-state imaging device.

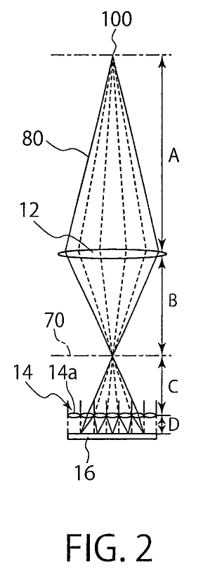

FIG. 2 shows the optical system of the solid-state imaging device of the first embodiment. In this example, the imaging optics 12 is formed with one imaging lens. Light beams 80 from an object 100 enter the imaging lens (the imaging optics) 12, and are imaged on an imaging plane 70. The image formed on the imaging plane 70 enters the microlens array 14, and is reduced and is imaged on the imaging element 16 by microlenses 14a constituting the microlens array 14. In FIG. 2, A represents the distance between the imaging lens 12 and the object 100, B represents the imaging distance of the imaging lens 12, C represents the distance between the imaging plane 70 and the microlens array 14, and D represents the distance between the microlens array 14 and the imaging element 16. In the following description, f represents the focal length of the imaging lens 12, and g represents the focal length of the microlenses 14a. In this specification, the front side is defined as the side of the object 100, and the rear side is defined as the side of the imaging element 16, with the center being the surface that passes through the center point of the imaging lens 12 and is perpendicular to the optical axis, for ease of explanation. In the optical system, the microlens array 14 divides the light beams from the imaging lens 12 into images from respective viewpoints, and reduces and images the divided beams on the imaging element 16.

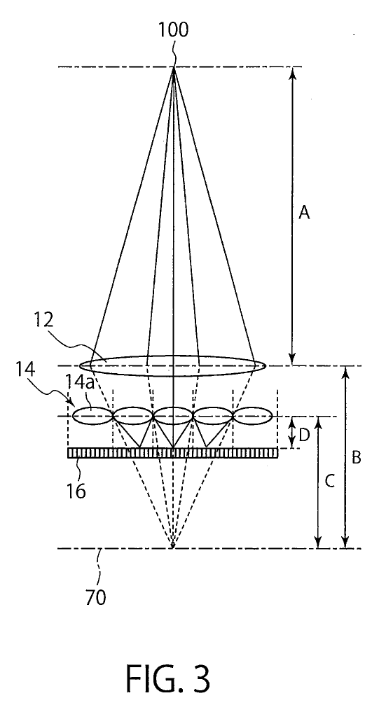

In the solid-state imaging device of this embodiment, the microlens array 14 is located on the rear side of the imaging plane 70 with respect to the imaging lens 12. In this embodiment, however, the optical system is not limited to that illustrated in FIG. 2, and the microlens array 14 may be located on the front side of the imaging plane 70 with respect to the imaging lens 12, for example, as illustrated in FIG. 3.

### (Microlens Array)

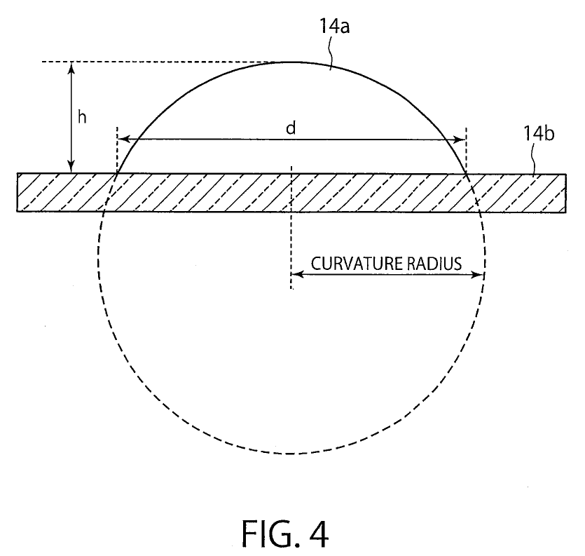

Next, the microlens array 14 used in the first embodiment is described. As shown in FIG. 4, the microlens array 14 has a structure in which microlenses are formed on a visible light transmissive substrate 14b. Although only one microlens 14a is shown in FIG. 4, at least two kinds of microlenses with different sizes are formed on the visible light transmissive substrate 14b. Here, the diameter d of the microlens 14a means the longest diameter of the region in which the microlens 14a is in contact with the visible light transmissive substrate 14b. The longest diameter means the largest value of the distance between two points on the circumference of the region in which the microlens 14a is in contact with the visible light transmissive substrate 14b. The height h of the microlens 14a means the largest value of the distance from the visible light transmissive substrate 14b to a point on the surface of the microlens 14a. That is, the height h of the microlens 14a is the distance from the visible light transmissive substrate 14b to the vertex of the microlens 14a. The diameter d and the height h of the microlens 14a are shown in FIG. 4.

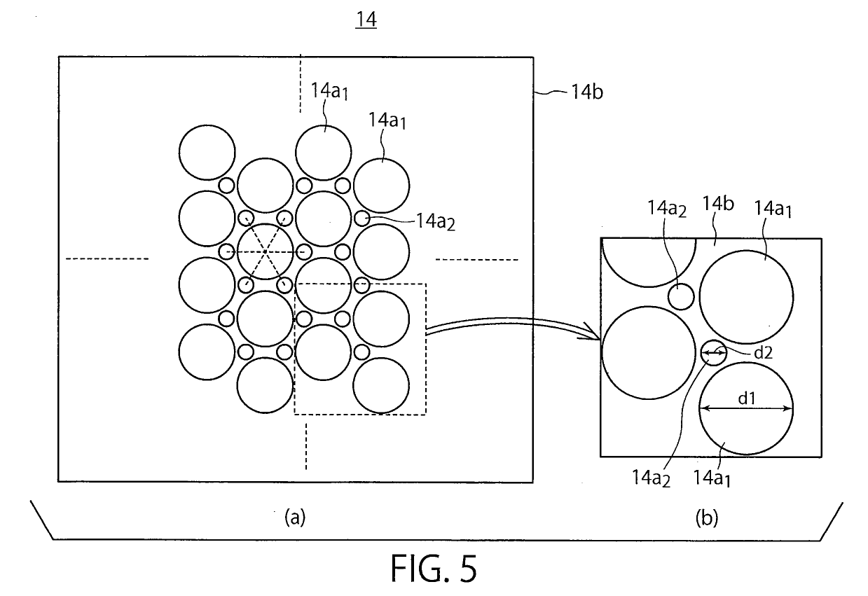

FIG. 5(a) is a plan view of the microlens array 14, and FIG. 5(b) is a partially enlarged view of the microlens array 14 shown in FIG. 5(a). As shown in FIGS. 5(a) and 5(b), the microlens array 14 used in this embodiment includes first microlenses 14a₁ and second microlenses 14a₂ that are formed on the visible light transmissive substrate 14b and have different sizes. The first microlenses 14a₁ each have a diameter d1, and the second microlenses 14a₂ each have a diameter d2 that is shorter than the diameter d1. The second microlenses 14a₂ are formed around the first microlenses 14a₁. For example, in the group of the first microlenses 14a₁ arranged in a column (in the longitudinal direction in FIG. 5(a)), the center points of the first microlenses 14a₁ are located substantially on the same line, and are arranged at substantially regular intervals. In a first column and a second column that are adjacent to each other and are formed with respective groups of first microlenses 14a₁, the center point of each first microlens 14a₁ of the second column is located between the center points of two adjacent first microlenses 14a₁ of the first column. That is, the first microlenses 14a₁ of the first column are shifted in the column direction, with respect to the first microlenses 14a₁ of the second column. In the above-described example, the column direction can be replaced with the row direction (the transverse direction in FIG. 5(a)). Each second microlens 14a₂ is located at a vertex of the hexagon surrounding the corresponding first microlens 14a₁, and is shared among the adjacent first microlenses 14a₁. That is, each first microlens 14a₁ is located in the middle of the second microlenses 14a₂ located at the vertices of the corresponding hexagon. The first microlenses 14a₁ are also called imaging microlenses, and the second microlenses 14a₂ are also called marker microlenses.

In FIGS. 5(a) and 5(b), two kinds of microlenses are shown. However, the present invention is actually not limited to that arrangement, and there can be three or more kinds of microlenses. The arrangement of the microlenses is not limited to the arrangement shown in FIGS. 5(a) and 5(b), either, and the imaging microlenses and the marker microlenses can be arranged in tetragons or a square lattice, for example. Each first microlens 14a₁ can be located in the middle of the second microlenses 14a₂ arranged at the vertices of the corresponding tetragon or square lattice. The imaging microlenses 14a₁ and the marker microlenses 14a₂ are both designed to form images on the same imaging plane, or on the imaging element 16. That is, the imaging microlenses 14a₁ and the marker microlenses 14a₂ reduce and reconstruct each image formed on an imaging plane by the imaging lens 12, into pixel blocks.

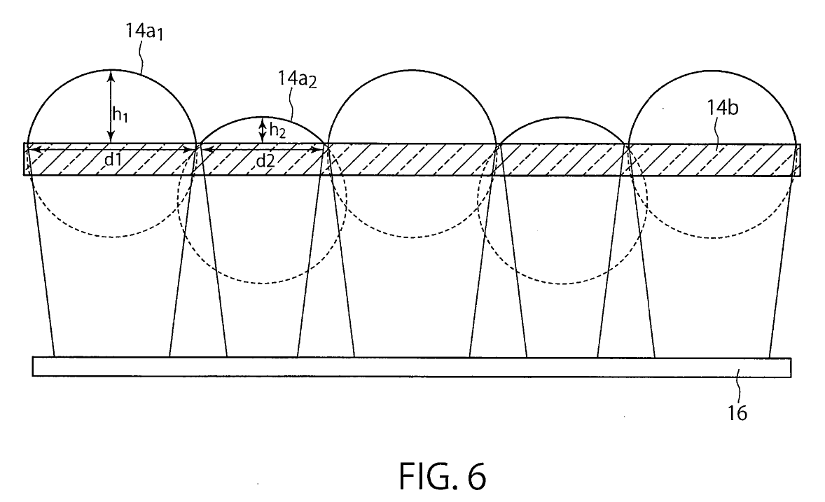

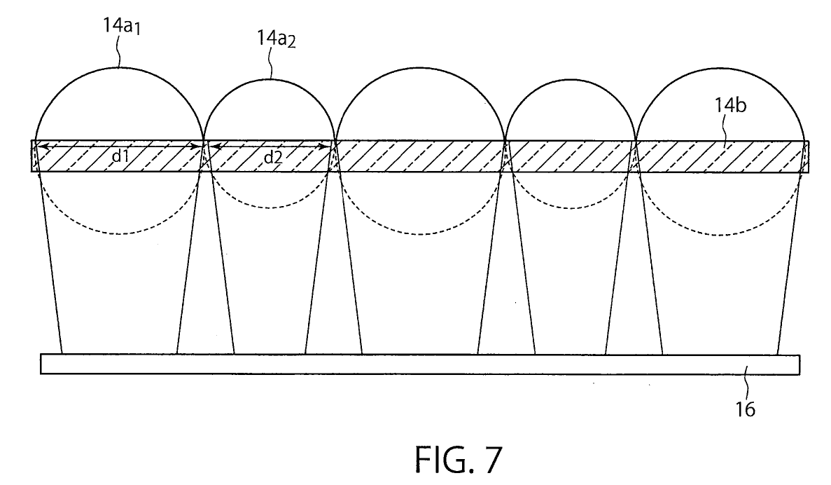

Referring now to FIGS. 6 and 7, the marker microlenses are described in detail. FIG. 6 is a cross-sectional view of a first example of marker microlenses, and FIG. 7 is a cross-sectional view of a second example of marker microlenses.

In the first example illustrated in FIG. 6, the imaging microlenses 14a₁ and the marker microlenses 14a₂ have the same curvature radii, and the imaging microlenses 14a₁ and the marker microlenses 14a₂ are made of the same material such as quartz glass or plastic. The height h₂ of each of the marker microlenses 14a₂, or the distance from the visible light transmissive substrate 14b to the vertex of each of the marker microlenses 14a₂, is smaller than the height h₁ of each of the imaging microlenses 14a₁. Having the same curvature radii, the marker microlenses 14a₂ and the imaging microlenses 14a₁ have the same focal lengths in the example illustrated in FIG. 6.

In the second example illustrated in FIG. 7, the imaging microlenses 14a₁ and the marker microlenses 14a₂ have different curvature radii. Although having different curvature radii, the marker microlenses 14a₂ and the imaging microlenses 14a₁ are designed to have substantially the same focal lengths in the second example illustrated in FIG. 7, as the refractive indices of the marker microlenses 14a₂ and the imaging microlenses 14a₁ are adjusted by selecting appropriate materials and the like so as to satisfy the lens paraxial theory formula. In either case illustrated in FIGS. 6 and 7, the diameter of each marker microlens 14a₂ is shorter than that of each imaging microlens 14a₁.

Next, general methods of manufacturing microlens arrays are briefly described. There are various kinds of methods of manufacturing microlens arrays. For the first example microlens array illustrated in FIG. 6, a method using a photoresist is now described as an example method. Specifically, by this method, a photoresist is exposed and developed to form a resist pattern, and the resist pattern is formed into convex lens shapes by thermal melting. As shown in FIG. 6, to achieve different microlens heights h₁ and h₂ (SAG amounts), a gray scale mask or the like is used at the marker microlens portions when a resist is applied. In this manner, the SAG amounts are adjusted.

A method of manufacturing the second example microlens array illustrated in FIG. 7 is described. In a case where the curvature radius varies as in the second example illustrated in FIG. 7, two types of masks of resist patterns with different bottom face radii are formed, and lens shapes are formed by thermal melting as in the first example illustrated in FIG. 6. In the microlens formation, a substrate having nanoparticles dispersed in the plane of a transparent material is used. For example, the microlenses can be formed by adding titanium oxide particles to acrylic resin at varying densities. This substrate is formed by controlling the refractive index at respective portions in accordance with the varying particle densities and sizes and the like. Microlens shapes are formed on the substrate by performing dry etching or the like. In this manner, the microlens array 14 formed with the imaging microlenses 14a₁ and the marker microlenses 14a₂ having different curvature radii and refractive indices can be formed.

### (Method of Determining the Center Position of an Imaging Lens)

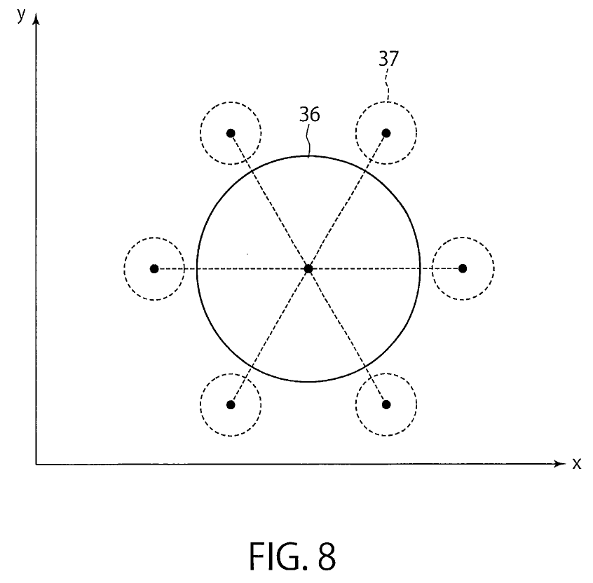

FIG. 8 shows an image 36 of an imaging microlens 14a₁ formed on the imaging element 16, and images 37 of the marker microlenses 14a₂ located around the imaging microlens 14a₁. To determine the center position of the image 36 of the imaging microlens 14a₁, the coordinates of the center position of each of the images 37 of the marker microlenses 14a₂ surrounding the imaging microlens 14a₁ are first determined by circular fitting or the like. In a case where the marker microlenses 14a₂ are located hexagonally and evenly around the imaging microlens 14a₁ as shown in FIG. 8, and where x₁, x₂, x₃, x₄, x₅, and x₆ represent the X-coordinates of the centers of the images 37 of the six marker microlenses 14a₂, the X-coordinate x₀ of the center of the image 36 of the imaging microlens 14a₁ is expressed by the following equation (1):

$${x}_{0} = \frac{{x}_{1} + {x}_{2} + {x}_{3} + {x}_{4} + {x}_{5} + {x}_{6}}{6} \qquad ( 1 )$$

Where the absolute value Δxᵢ of the detection error of the X-coordinate xᵢ (i=1, . . . , 6) of the center of each marker microlens 14a₂ in this case is expressed as

Δx₁=Δx₂=Δx₃=Δx₄=Δx₅=Δx₆=Δ (2),

the detection error Δx₀ of the X-coordinate of the center of the imaging microlens 14a₁ is expressed by using error propagation as follows:

$$Δ {x}_{0} = \frac{Δ}{\sqrt{6}} \qquad ( 3 )$$

Here, Δ represents the detection error of a marker microlens. In this manner, the X-coordinate of the center of an imaging microlens can be determined with a higher degree of accuracy than the X-coordinate of the center of a single marker microlens. The Y-coordinate can be determined in the same manner as above, and the two-dimensional coordinates of the center position of an image of an imaging microlens in an obtained image can be obtained. Since the detection errors Δx₀ and Δy₀ of center coordinates obtained in this manner are smaller than the detection errors of marker microlenses, the artifacts in a reconstructed two-dimensional image described later can be reduced, and image quality can be improved.

(Method of Determining the Center Position of an Imaging Lens Image from an Incomplete Imaging Lens Image)

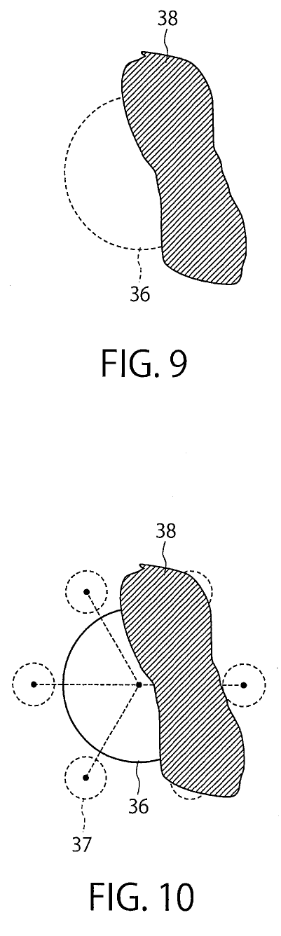

FIG. 9 shows a microlens image in a case where there is dust or a scratch on the microlens array. Where an image 38 of dust or a scratch on the microlens array overlaps an image 36 of an imaging microlens 14a₁ with no marker microlenses existing nearby, it is difficult to detect the center position of the microlens image by circular fitting or the like.

In the first embodiment illustrated in FIG. 10, on the other hand, marker microlenses 14a₂ are located around an imaging microlens 14a₁. In this case, even if it is difficult to detect some of the images 37 of the marker microlenses 14a₂, the center position of the image of the imaging microlens 14a₁ can be determined from the remaining images 37 of the marker microlenses 14a₂.

### (Effects of Marker Microlenses on Image Fitting)

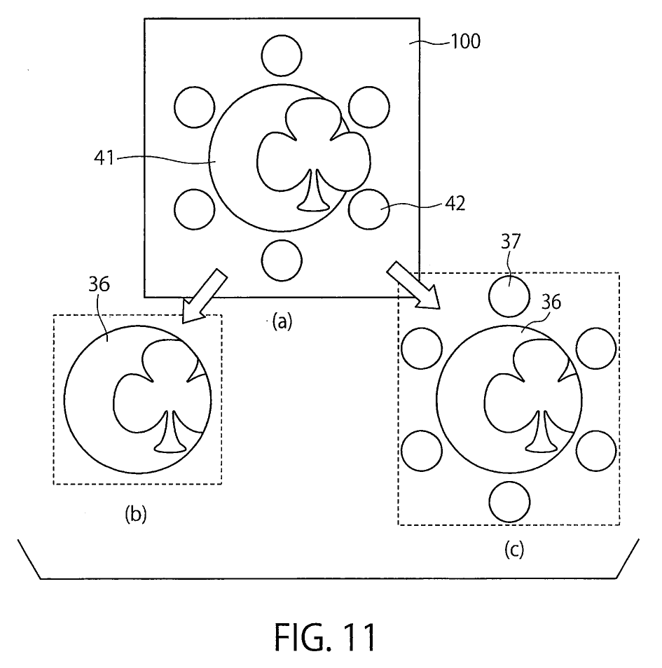

Referring now to FIGS. 11(a) through 11(c), the effects of marker microlenses 14a₂ located around an imaging microlens 14a₁ on image fitting in the first embodiment are described. It is assumed that an object 100 is located in front of an optical system, and the field of view 41 of the imaging microlens 14a₁ and the fields of view 42 of the marker microlenses 14a₂ are located as shown in FIG. 11(a). If the marker microlenses 14a₂ are not provided, the resultant image is the image shown in FIG. 11(b). In this case, the luminance values in the microlens image vary with object images, and the circular fitting accuracy depending on the contour of each single image is degraded.

In this embodiment, on the other hand, the image obtained in a case where marker microlenses 14a₂ are located around an imaging microlens 14a₁ is the image shown in FIG. 11(c). In this case, the fields of view of the marker microlenses 14a₂ are smaller than that of the imaging microlens 14a₁, and accordingly, there is a higher possibility that an image of the object with relatively uniform luminance can be captured. Therefore, the contours of the images 37 of the marker microlenses 14a₂ with uniform luminance values are approximated by circular fitting, and the center coordinates are determined. In this manner, the coordinates of the center positions of a two-dimensional image for reconstruction and an imaging microlens can be determined by a single image capturing operation.

Further, even if the object 100 overlaps some of the images 37 of the marker microlenses 14a₂, and the luminance values are not uniform, the center coordinates of the image 36 of the imaging microlens 14a₁ can be determined from the remaining images 37 of the marker microlenses 14a₂ by the same restoring method as the above-described method.

### (Method of Obtaining Two-Dimensional Image by Reconstruction)

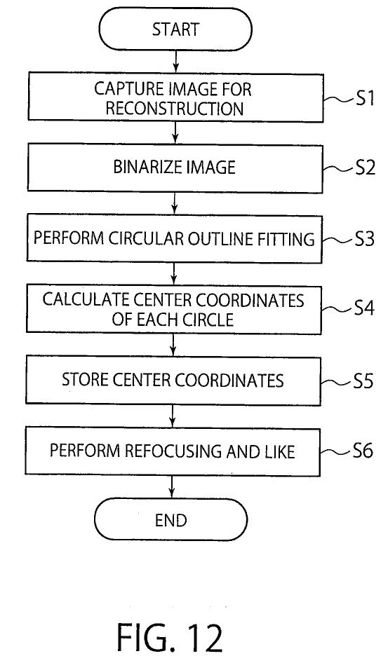

Next, a method of obtaining a two-dimensional image by reconstruction is described. FIG. 12 is a flowchart of an operation to obtain a two-dimensional image by using marker microlenses.

First, an image for reconstruction is captured by a manual operation (step S1). The captured image is then binarized (step S2). Fitting is performed on the assumption that the contour of each marker microlens is circular (step S3). The center coordinates of the circle of each of the images of the marker microlenses are calculated, and the center coordinates of the image of the imaging microlens are calculated by using the center coordinates of the images of the marker microlenses (step S4). The calculated center coordinates of the image of the imaging microlens are stored into a memory or the like (step S5). By using the stored center coordinates, refocusing and the like are performed (step S6). The manual operation to be performed by a user is only to take a photograph (the image for reconstruction) like a conventional camera operation, and the calibration and the like for detecting the center coordinates can be skipped.

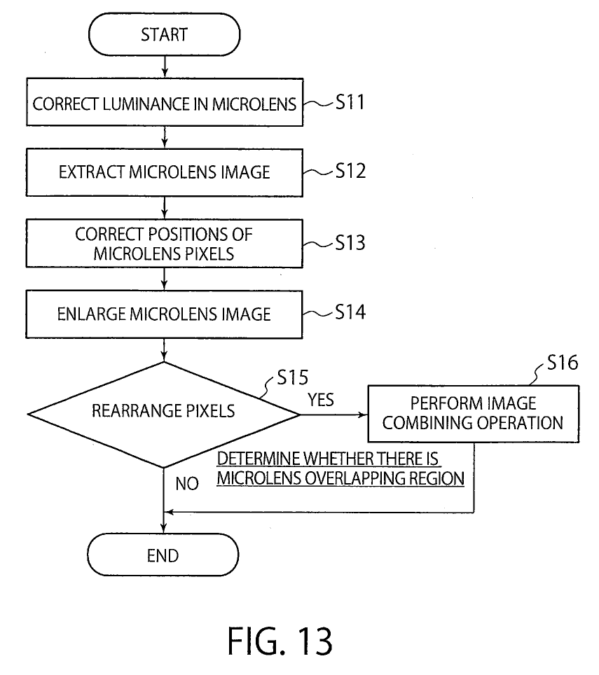

FIG. 13 is a flowchart of an operation to obtain a two-dimensional image based on the stored center coordinates and the binarized image.

First, a luminance correction is performed on the image in the imaging microlens through a correcting operation such as shading (step S11). The imaging microlens region is then extracted (step S12). A distortion correcting operation is performed on each of the pixels in the imaging microlens by using the stored center coordinates, to correct the position (step S13). After that, the image of the imaging microlens is enlarged (step S14). A check is then made to determine whether there is a microlens overlapping region (step S15). If there are no overlapping regions, the operation is ended without pixel rearrangement. If there is a microlens overlapping region, the pixels are rearranged, and an image combining operation is performed (step S16).

As described above, to obtain a two-dimensional image, an imaging lens image is extracted by using the center coordinates of the imaging lens calculated from marker microlenses, and the imaging lens image is enlarged to combine imaging microlens images. The combined image is the desired two-dimensional image.

(Effect to Increase Optical System Assembly Accuracy where Color Filters are Combined)

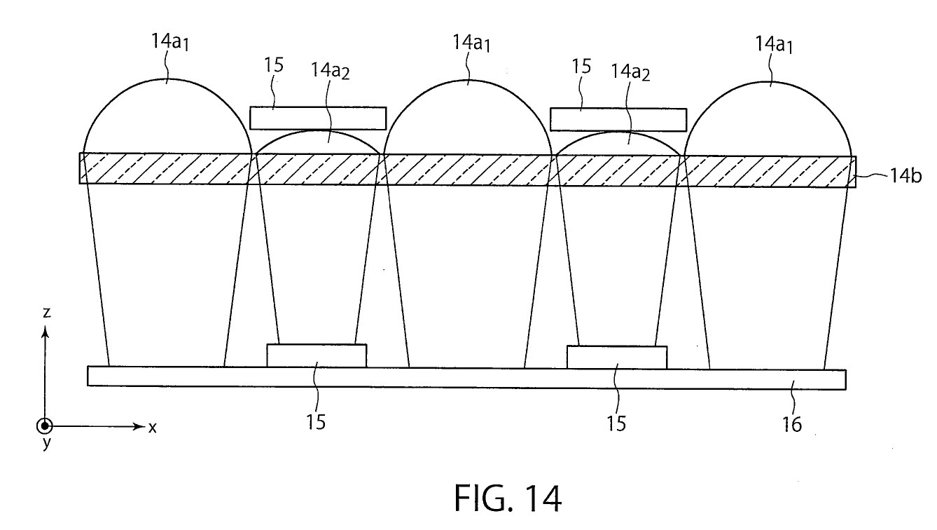

Next, a case where color filters are provided on the microlens array 14 is described. FIG. 14 shows an optical system in a case where color filters 15 are placed on the surfaces of the marker microlenses 14a₂ on the microlens array 14 and on the surfaces of the images of the marker microlenses 14a₂ formed on the imaging element 16. Specifically, second color filters of at least one color of R (red), G (green), and B (blue) are provided between the second microlenses 14a₂ and the imaging lens 12, and first color filters of the same color(s) as the second color filters are provided on the side of the imaging element 16 facing the second microlenses 14a₂. In other words, the imaging element 16 has pixels having color filters that pass the same color(s) as the color filters in the regions facing the color filters provided on the surfaces of the marker microlenses 14a₂.

Here, the positions in which the color filters 15 are provided are not limited to the positions shown in FIG. 14, but can be provided on surfaces closer to the imaging element 16, for example. The color filters 15 are not of one kind, and several kinds of color filters, such as R (red) filters, G (green) filters, and B (blue) filters are provided. The filters of the respective colors are arranged in the same manner both on the surfaces of the marker microlenses 14a₂ and on the surfaces of the images of the marker microlenses 14a₂. Where the microlens array 14 and the imaging element 16 are put together in this situation, images of the marker microlenses 14a₂ cannot be formed or can be deformed if the colors of the color filters 15 on the marker microlenses 14a₂ do not correspond to the colors of the color filters on the imaging element 16. Therefore, positioning in the x-y direction can be performed by determining whether there are marker microlens images and checking for image distortions.

After the positioning in the x-y direction is performed and all the images of the marker microlenses 14a₂ are obtained, positioning in the z-direction can be performed by determining the magnifications of the images in the marker microlens images. Accordingly, three-dimensional positioning can be performed by using the marker microlenses 14a₂. Also, by examining the size distributions of the images of the marker microlenses 14a₂, the tilt of the microlens array 14 can be measured. By using the measurement value, the tilt of the microlens array 14 with respect to the imaging element 16 at the time of assembling can be corrected.

By an example method of manufacturing the color filters 15 on the microlens array 14, an organic pigment resist is applied to the microlens array 14. This is a method of forming the color filters 15 by applying a resist having organic pigments dispersed therein to the plain surface of the visible light transmissive substrate 14b on the opposite side from the surface having the microlenses 14 formed thereon, and exposing and developing only the portions corresponding to the marker microlenses 14a₂. The color filters 15 on the imaging element 16 are formed by a conventional manufacturing method. At this point, however, only the color filters 15 in the regions facing the marker microlenses 14a₂ need to be color filters of the colors corresponding to the color filters 15 on the marker microlenses 14a₂. The microlens array 14 having the color filters 15 formed thereon is combined with the imaging element 16 having the color filters 15 formed thereon, so that the assembly accuracy at the time of assembling of the imaging element 16 and the microlens array 14 can be increased.

(Effect to Increase Marker Microlens Detection Rate with White Pixels (W Pixels))

In this specification, pixels having color filters of the R color formed thereon are called R pixels, pixels having color filters of the G color formed thereon are called G pixels, pixels having color filters of the B color are called B pixels, and pixels having no color filters formed thereon are called white pixels (W pixels).

The effects of combining the marker microlenses 14a₂ with white pixels are now described. Normally, color filters in a Bayer arrangement are placed on the respective pixels of an imaging element, and a two-dimensional image is captured by the color filters obtaining respective signals of the R, G, and B pixels. As light attenuates when passing through a color filter, detected luminance values are smaller than the luminance value of incident light.

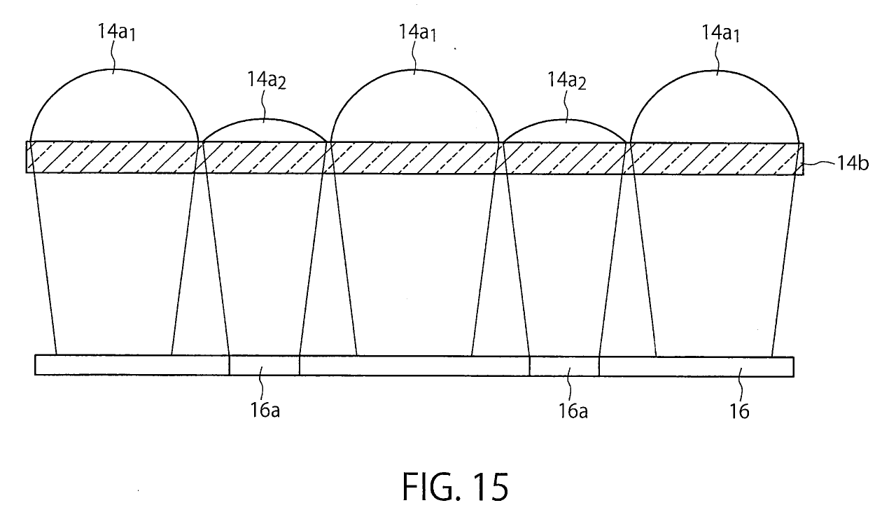

In FIG. 15, on the contrary, the pixels in the imaging regions where the images of the marker microlenses 14a₂ are formed are white pixels. That is, color filters are not provided between the second microlenses 14a₂ and the imaging lens 12, and color filters are not provided between the second microlenses 14a₂ and the imaging element 16 either. Since incident light directly enters the pixels in this case, detected luminance values are larger than those obtained through the R pixels, G pixels, and B pixels. Accordingly, signals are easily saturated in a case where white pixels are used as the pixels in the imaging regions 16a for the marker microlenses 14a₂. Thus, there is a higher possibility that uniform marker microlens images can be obtained, and the number of marker microlenses 14a₂ on which image contour fitting can be performed becomes larger. Further, since the luminance values are larger than in a case where the color filters 15 are provided, the contours of the images of the marker microlenses 14a₂ can be detected even in a circumstance such as a room with a small amount of light. Accordingly, by combining white pixels with the marker microlenses 14a₂, the accuracy of detecting the center coordinates of microlenses can be increased. Also, the center coordinates of the microlenses 14a₂ can be detected even in a place with a small amount of light.

(Method of Obtaining a Two-Dimensional Polarization Image by Combining Polarizing Plates with Marker Microlenses)

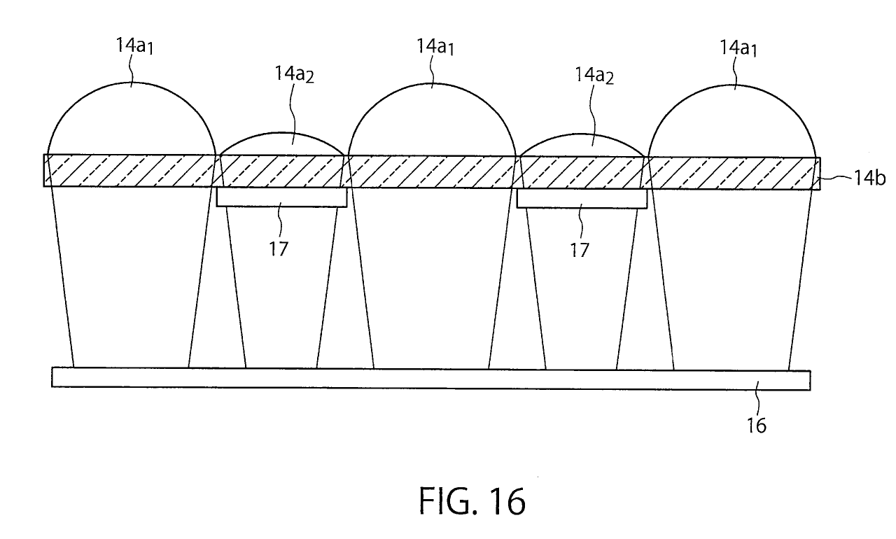

FIG. 16 shows an optical system in a case where polarizing plates 17 are provided on the plain surface of the microlens array 14. The positions in which the polarizing plates 17 are provided are not limited to the positions shown in FIG. 16, and can be located closer to the imaging element 16 or may be placed on the marker microlenses 14a₂, for example.

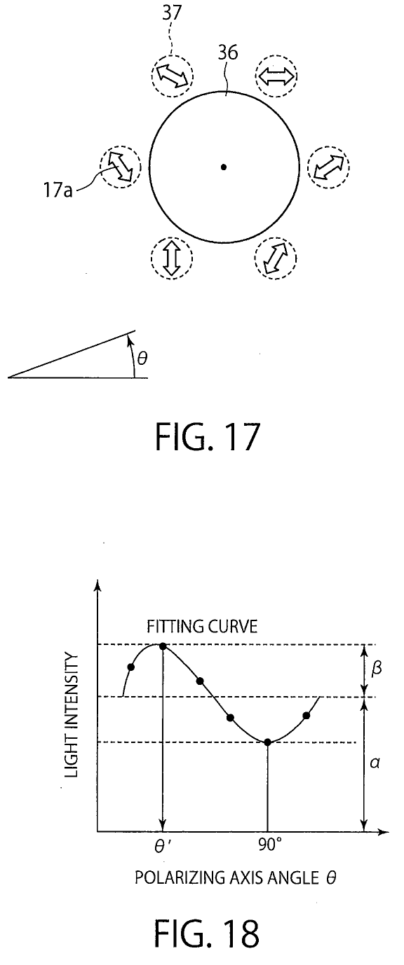

By an example method of manufacturing the polarizing plates 17 used in this case, microstructural thin films are stacked by sputtering. A polarizing plate array formed by stacking sputtered thin films on the visible transmissive substrate 14b is bonded to the microlens array 14, with the positions of the marker microlenses 14a₂ being adjusted to the positions of the polarizing plates 17. In this manner, marker microlenses with polarizing plates can be formed. The polarizing plates 17 are not of one kind, and several kinds of polarizing plates with different polarizing axes are provided as shown in FIG. 17, for example. Those polarizing plates 17 are arranged in the same manner both on the surfaces of the marker microlenses 14a₂ and on the surfaces of the images of the marker microlenses 14a₂. When the microlens array 14 and the imaging element 16 are put together in this situation, the luminance values of the marker microlens images become smaller if the polarizing axes of the polarizing plates 17 for the marker microlenses 14a₂ do not correspond to the principal polarizing axis of incident light.

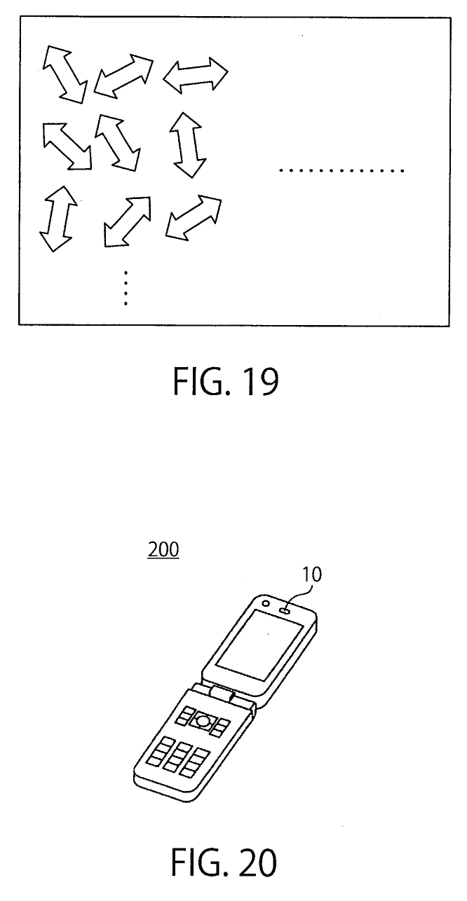

Further, as shown in FIG. 17, the angles 9 of the polarizing axes 17a of the polarizing plates 17 on the marker microlenses 14a₂ surrounding an imaging microlens 14a₁ may be of the six kinds: 0°, 30°, 60°, 90°, 120°, and 150°. At this point, the values of the respective marker microlenses 14a₂ are plotted in a graph indicating the polarizing axis angle 9 on the abscissa axis and the light intensity on the ordinate axis, and fitting is performed, as shown in FIG. 18. In this manner, the principal polarizing axis θ′ of light incident on the imaging microlens 14a₁ surrounded by the marker microlenses 14a₂ can be determined. A two-dimensional principal polarizing axis distribution can be obtained as shown in FIG. 19, by performing the above operation on all the marker microlenses 14a₂. That is, by combining the marker microlenses 14a₂ with the polarizing plates 17, a two-dimensional polarizing angle distribution can be determined.

If there is a scratch or the like on a uniform object surface, the polarization properties of reflected light differ between the scratch region and the surrounding uniform regions. Also, since the distance to an object can be measured by using imaging microlens images as will be described later, this embodiment can be applied to a testing apparatus using the object distance information and a two-dimensional polarization distribution. More specifically, a two-dimensional image of an object is captured while the lens is focused on the object to be tested with imaging microlens images, and the position and the length of the scratch are measured with a two-dimensional polarization distribution obtained by the marker microlenses. In this case, it is possible to realize a testing apparatus that can conduct a visual test with visible light and check for scratches that are difficult to see with visible light on the surface prior to shipping of products, for example.

### (Method of Measuring the Distance to an Object)

A method of measuring the distance to the object 100 in an example using the optical system illustrated in FIG. 2 is now described. When the distance A between the lens 12 and the object 100 varies, the value of the imaging distance B varies as can be seen from the equation (4):

$$\frac{1}{A} + \frac{1}{B} = \frac{1}{f} \qquad ( 4 )$$

Since the equation B+C=E is satisfied by the positional relationship in the optical system, the value of the distance C varies with the imaging distance B. By using the equation (5) for the microlenses, it is apparent that the value of the distance D varies with the distance C.

$$\frac{1}{C} + \frac{1}{D} = \frac{1}{g} \qquad ( 5 )$$

As a result, the image formed through each microlens of the microlens array 14 is an image that is M (M=D/C) times smaller than the imaging plane 70, which is a virtual image of the imaging lens 12, and is expressed by the following equation (6):

$$\frac{D}{C} = \frac{D}{E - B} = \frac{D}{E - \frac{Af}{A - f}} = \frac{D ( A - f )}{E ( A - f ) - Af} = M \qquad ( 6 )$$

As the value of the object distance A varies, the values of B, C, and D also vary. Therefore, the reduction magnification ratio M of the microlens image also varies.

Based on the equation (6), A is expressed as:

$$A = \frac{( D - ME ) f}{D - ME + Mf} \qquad ( 7 )$$

Accordingly, the image reduction magnification ratio M of the microlenses can be calculated by image matching and the like, and, if the values of D, E, and f are known, the value of A can be determined according to the equation (7).

The equation E+C=B is satisfied in the case of the optical system illustrated in FIG. 3, and the lens equation about the microlenses is the following equation (8):

$$- \frac{1}{C} + \frac{1}{D} = \frac{1}{g} \qquad ( 8 )$$

Accordingly, the relationship between A and M in this case can be expressed by the following equation (9):

$$A = \frac{( D + ME ) f}{D + ME - Mf} \qquad ( 9 )$$

Where Δ′ represents the image shift length between microlenses, and L represents the distance between the centers of microlenses, the reduction magnification ratio M can be expressed as follows, based on the geometric relationship between light beams:

$$M = \frac{{Δ}^{′}}{L}$$

Accordingly, to determine the reduction magnification ratio M, the image shift length between microlenses should be determined by image matching using evaluation values such as SADs and SSDs.

By the method of the first embodiment, the center coordinates of the imaging microlenses can be detected with high precision. Accordingly, the accuracy of the value Δ′ in the distance calculation becomes higher, and as a result, the object distance Δ can be determined with high precision.

According to the first embodiment, the center coordinates of microlenses can be calculated with higher precision. Accordingly, artifacts in a two-dimensional reconstructed image can be reduced, and image quality is increased. Also, the accuracy of distance estimates becomes higher. Furthermore, there is no need to capture an image for calibration prior to image formation.

As described above, the first embodiment can provide a solid-state imaging device that can detect the center coordinates of microlenses with high precision, and does not need to capture an image for calibration.

The marker microlenses are not necessarily provided around all the imaging microlenses, and may be located around only some of the imaging microlenses.

### Second Embodiment

FIG. 20 shows a portable information terminal according to a second embodiment. The portable information terminal 200 of the second embodiment uses the solid-state imaging device of the first embodiment. The portable information terminal illustrated in FIG. 20 is an example, and reference numeral 10 indicates the imaging module of the solid-state imaging device of the first embodiment. In this manner, the solid-state imaging device of the first embodiment can be applied not only to still cameras but also to the portable information terminal 200 and the like.

As described above, the second embodiment can provide a portable information terminal that can detect the center coordinates of microlenses with high precision, and does not need to capture an image for calibration.

While certain embodiments have been described, these embodiments have been presented by way of example only, and are not intended to limit the scope of the inventions. Indeed, the novel methods and systems described herein can be embodied in a variety of other forms; furthermore, various omissions, substitutions and changes in the form of the methods and systems described herein can be made without departing from the spirit of the inventions. The accompanying claims and their equivalents are intended to cover such forms or modifications as would fall within the scope and spirit of the inventions.

What is claimed is:

1. A solid-state imaging device comprising:
an imaging element including a plurality of pixel blocks each containing a plurality of pixels;
a first optical system configured to form an image of an object on an imaging plane; and
a second optical system including a microlens array, the microlens array including a light transmissive substrate, a plurality of first microlenses formed on the light transmissive substrate, and a plurality of second microlenses formed around the first microlenses, a focal length of the first microlenses being substantially equal to a focal length of the second microlenses, an area of the first microlenses in contact with the light transmissive substrate being larger than an area of the second microlenses in contact with the light transmissive substrate, the second optical system being located between the imaging element and the first optical system, the second optical system being configured to reduce and reconstruct the image formed on the imaging plane on the pixel blocks via the microlens array.

2. The device according to claim 1, wherein the second microlenses are located at vertices of hexagons or tetragons, and the first microlenses are located inside the hexagons or tetragons formed by the second microlenses.

3. The device according to claim 1, wherein the first microlenses and the second microlenses are made of the same material, have the same curvature radius, and have different heights from the light transmissive substrate.

4. The device according to claim 1, wherein the first microlenses and the second microlenses are made of different materials and have different curvature radii from each other.

5. The device according to claim 1, wherein second color filters of at least one color of R, G, and B are provided between the second microlenses and the first optical system, and first color filters of the same color as the second color filters are provided in regions of the imaging element, the regions facing the second color filters.

6. The device according to claim 1, wherein the pixels of the imaging element are R pixels, G pixels, B pixels, or W pixels, and the pixels in regions of images of the second microlenses are W pixels.

7. The device according to claim 1, further comprising polarizing plates in positions on a surface of the light transmissive substrate on the opposite side from the surface having the second microlenses formed thereon, or positions on the imaging element, the positions corresponding to the second microlenses.

8. The device according to claim 1, further comprising a signal processing unit configured to perform an operation to detect coordinates of center positions of the first microlenses, based on images of the second microlenses.

9. The device according to claim 8, wherein the signal processing unit performs an operation to reconstruct a two-dimensional image from an image captured by the imaging element, using the detected coordinates of the center positions of the first microlenses.

10. A portable information terminal comprising the solid-state imaging device according to claim 1.

11. The terminal according to claim 10, wherein the second microlenses are located at vertices of hexagons or tetragons, and the first microlenses are located inside the hexagons or tetragons formed by the second microlenses.

12. The terminal according to claim 10, wherein the first microlenses and the second microlenses are made of the same material, have the same curvature radius, and have different heights from the light transmissive substrate.

13. The terminal according to claim 10, wherein the first microlenses and the second microlenses are made of different materials and have different curvature radii from each other.

14. The terminal according to claim 10, wherein second color filters of at least one color of R, G, and B are provided between the second microlenses and the first optical system, and first color filters of the same color as the second color filters are provided in regions of the imaging element, the regions facing the second color filters.

15. The terminal according to claim 10, wherein the pixels of the imaging element are R pixels, G pixels, B pixels, or W pixels, and the pixels in regions of images of the second microlenses are W pixels.

16. The terminal according to claim 10, further comprising polarizing plates in positions on a surface of the light transmissive substrate on the opposite side from the surface having the second microlenses formed thereon, or positions on the imaging element, the positions corresponding to the second microlenses.

17. The terminal according to claim 10, further comprising a signal processing unit configured to perform an operation to detect coordinates of center positions of the first microlenses, based on images of the second microlenses.

18. The terminal according to claim 17, wherein the signal processing unit performs an operation to reconstruct a two-dimensional image from an image captured by the imaging element, using the detected coordinates of the center positions of the first microlenses.
